(19) United States
(12) Patent Application Publication
(10) Pub. No.: US 2008/0267495 A1
(43) Pub. Date: Oct. 30, 2008

(54) Image compressing method and image compressing apparatus

(75) Inventor: Atsushi Shimura, Shiojiri-shi (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/080,477

(22) Filed: Apr. 3, 2008

(30) Foreign Application Priority Data
Apr. 6, 2007 (JP) 2007-101053

(51) Int. Cl. G06K 9/36

(52) U.S. Cl. 382/166

(57) ABSTRACT

An image compressing method of dividing and compressing a color image, in which each of pixels is represented by a brightness signal and two color difference signals, into a plurality of blocks including a plurality of pixels, the image compressing method including a compressing step of compressing the color image including the block in which the color difference signal is converted by at least one of a monochrome converting step, a zero value converting step or a correction value converting step.

The entire disclosure of Japanese Patent Application No. 2007-101053, filed Apr. 6, 2007 is expressly incorporated by reference herein.

### BACKGROUND

1. Technical Field

The present invention relates to an image compressing method and an image compressing apparatus.

2. Related Art

An image data compressing/encoding apparatus for fixing a color difference component of image data to a predetermined value if a monochrome processing mode is selected and compressing and encoding the fixed color difference component and a brightness component by a compressing/encoding unit is known (for example, see Patent Document 1).

[Patent Document 1] Japanese Unexamined Patent Application Publication No. 10-271530

The image data compressing/encoding apparatus disclosed in Patent Document 1 converts two color difference signal values of a substantially monochrome pixel, in which the two color difference signal values are all equal to or less than a threshold value close to zero, into zero and then converts it into a frequency domain, although a color image is compressed. Accordingly, in the case where compression is performed for each block, if a block including a large amount of pixels in which the two color difference signal values are in the threshold value and other block are adjacent to each other, block noise between the both blocks is conspicuous. In the case where an original image includes a gradation around the threshold value, the gradation is not reproduced in the image after compression.

### SUMMARY OF THE INVENTION

According to an aspect of the present invention, there is provided an image compressing method of dividing and compressing a color image, in which each of pixels is represented by a brightness signal and two color difference signals, into a plurality of blocks including a plurality of pixels, the image compressing method including: a determining step of determining whether absolute values of the color difference signals of the pixels of the color image are equal to or greater than a first threshold; a monochrome converting step of converting all the values of the two color difference signals of all the pixels included in a block into zero, if it is determined that the number of pixels, in which all the absolute values of the two color difference signals in the pixels included in the block are less than the first threshold is equal to or greater than a predetermined number, on the basis of the determined result of the determining step; a zero value converting step of extracting a pixel, in which the absolute value of one color difference signal is less than the first threshold, from the block and converting the value of the color difference signal of the extracted pixel into zero, if it is determined that the number of pixels, in which all the absolute values of the two color difference signals in the pixels included in the block are less than the first threshold is less than the predetermined number, on the basis of the determined result of the determining step; a correction value converting step of extracting a pixel, in which the absolute value of one color difference signal is equal to or greater than the first threshold, from the block and converting the value of the color difference signal of the extracted pixel into a correction value close to zero as the absolute value of the color difference signal is decreased, if it is determined that the number of pixels, in which all the absolute values of the two color difference signals in the pixels included in the block are less than the first threshold is less than the predetermined number, on the basis of the determined result of the determining step; and a compressing step of compressing the color image including the block in which the color difference signal is converted by at least one of the monochrome converting step, the zero value converting step or the correction value converting step.

Accordingly, it is possible to easily generate a compression image in which occurrence of block noise is suppressed, while shortening a time necessary for compression.

A function for converting the value of the color difference signal into the correction value by the correction value converting step may output a maximum value if the absolute value of the color difference signal of the pixel is the maximum value, which can be taken with respect to the color difference signal, and output zero if the absolute value of the color difference signal of the pixel is the same value as the first threshold. Accordingly, it is possible to easily generate a compression image in which occurrence of block noise is suppressed.

The determining step may further include determining whether the absolute values of the color difference signals of the pixels of the color image are equal to or greater than a second threshold greater than the first threshold, and the correction value converting step may include extracting a pixel, in which the absolute value of one color difference signal is equal to or greater than the second threshold, from the block and outputting the value of the color difference signal of the extracted pixel without conversion, on the basis of the determined result of the determining step. Accordingly, it is possible to easily generate a compression image in which occurrence of block noise is suppressed while shortening a time necessary for compression and generate a compression image in which an original image color is maintained.

The correction value converting step may include outputting the values of the color difference signals of all the pixels included in the block without conversion, if it is determined that the number of pixels, in which all the absolute values of the two color difference signals in the pixels included in the block are equal to greater than the second threshold is equal to or greater than the predetermined number, on the basis of the determined result of the determining step. Accordingly, it is possible to generate a compression image in which an original image color is maintained.

The method of the invention may be realized as a program executed by a computer and an image compressing apparatus.

The summary of the invention does not describe all the necessary features of the invention and a sub-combination of features may be included in the invention.

### BRIEF DESCRIPTION OF THE INVENTION

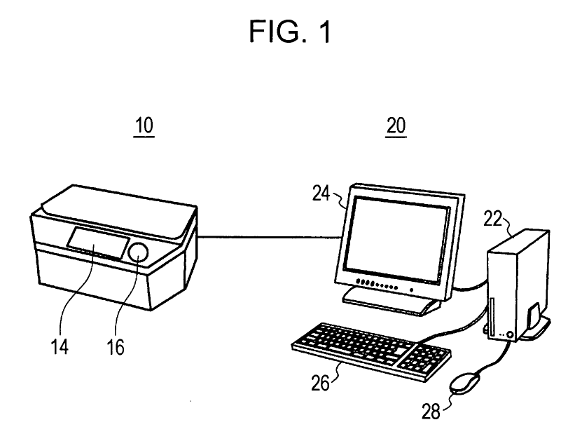

FIG. 1 is a view showing a scanner 10.

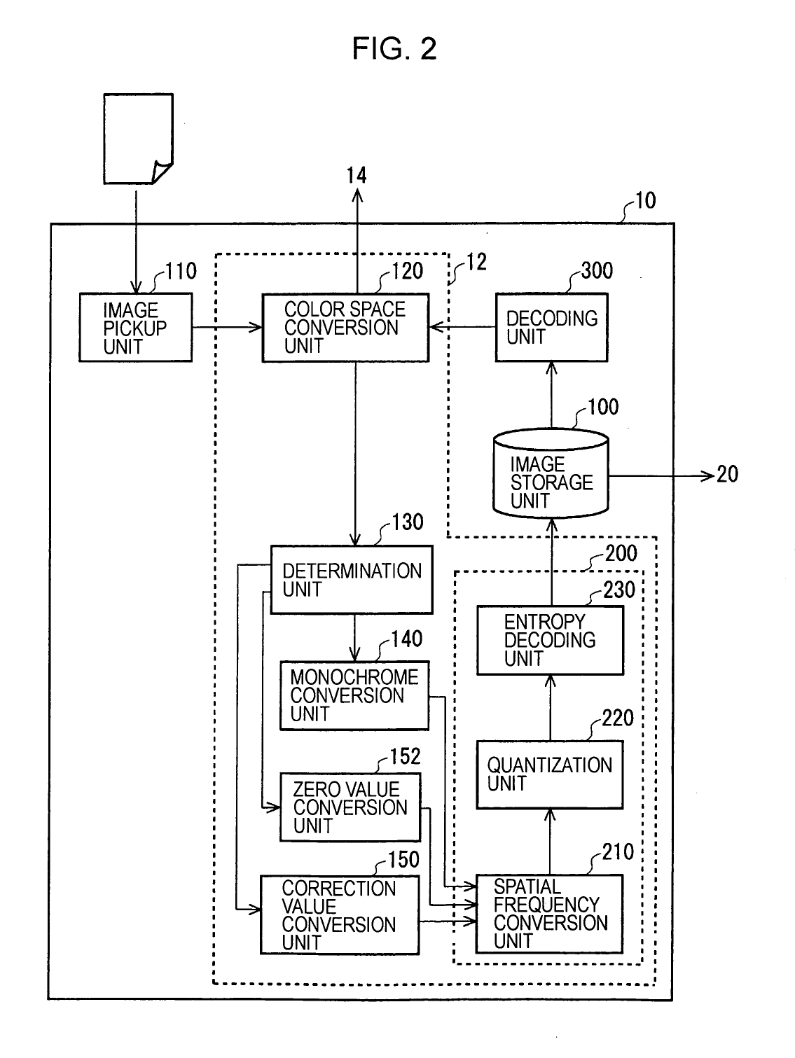

FIG. 2 is a block diagram showing an example of the scanner 10.

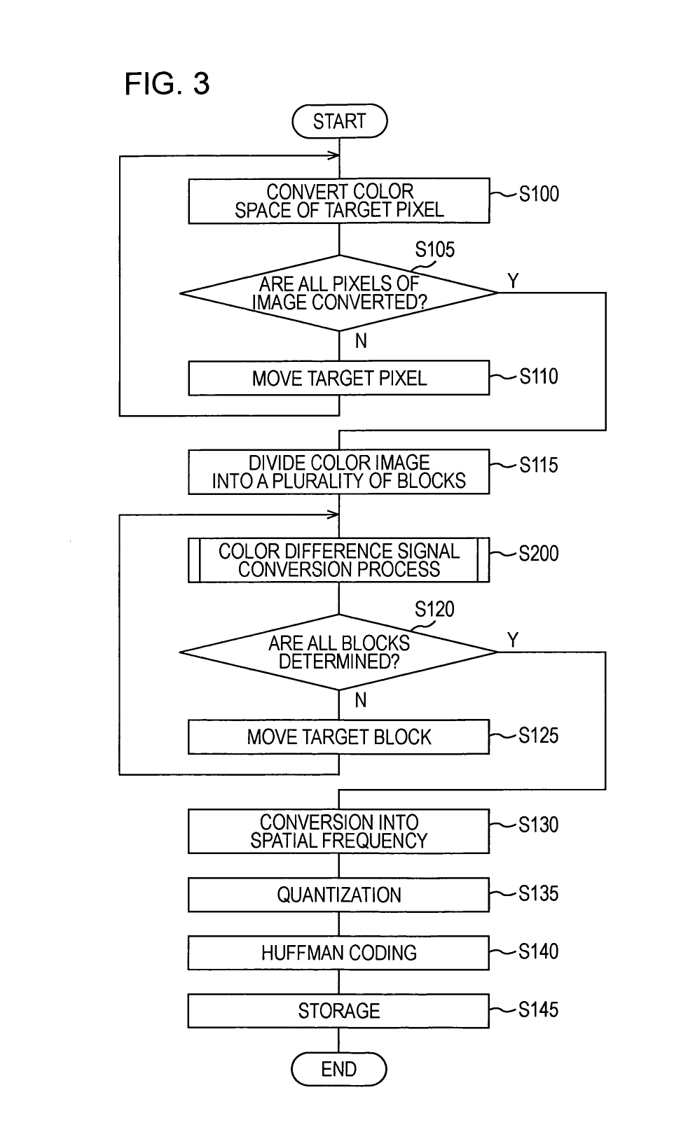

FIG. 3 is a flowchart showing an example of an operation of the scanner 10.

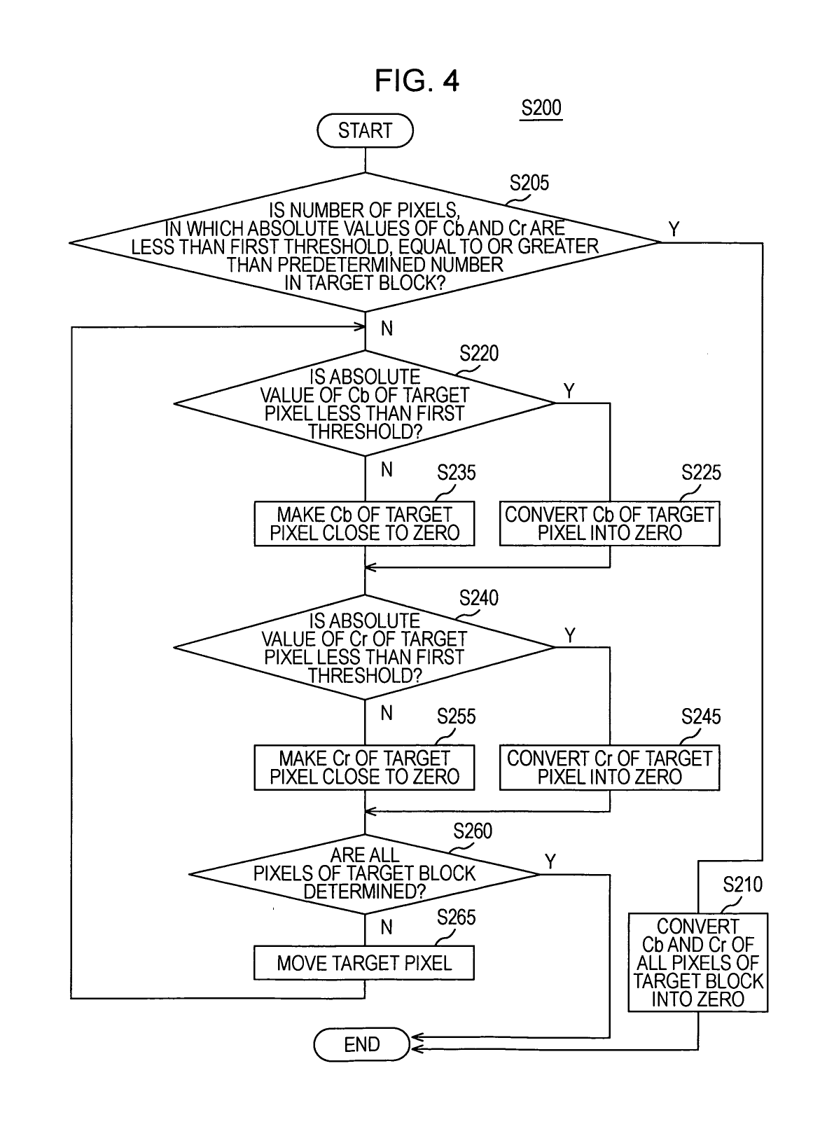

FIG. 4 is a flowchart showing an example of the operation of the scanner 10.

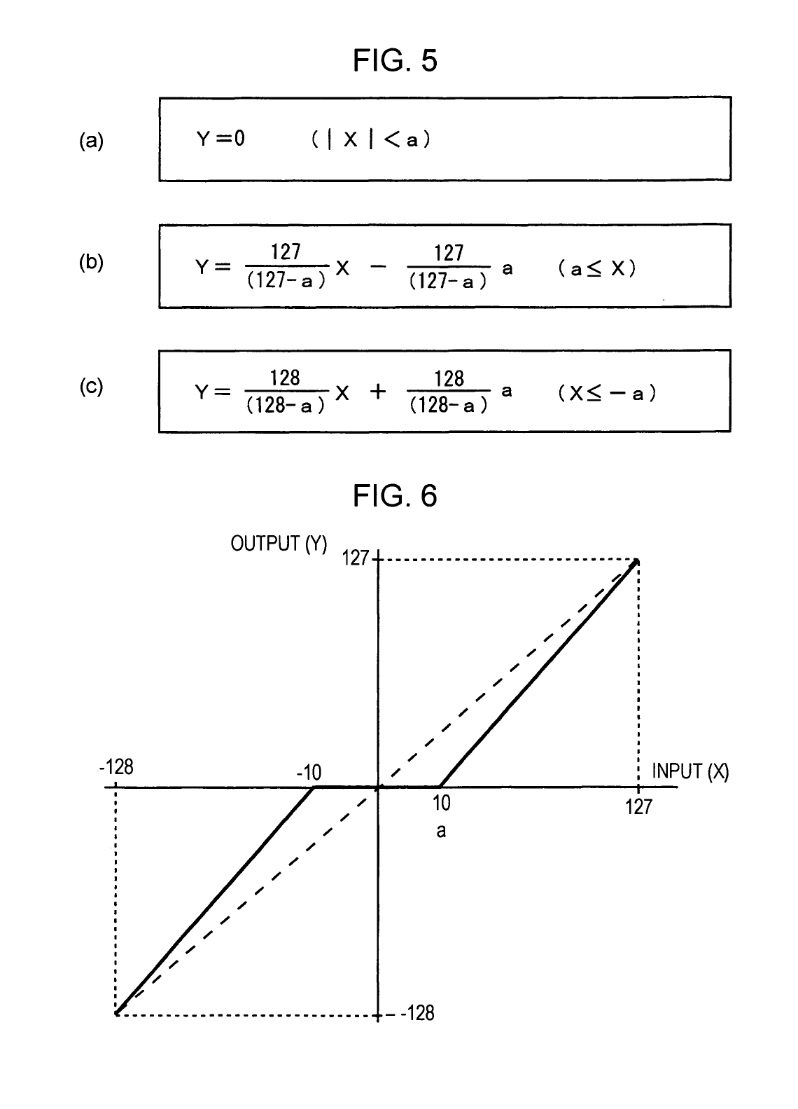

FIG. 5 is a view showing an example of a conversion equation of a color difference signal.

FIG. 6 is a schematic view showing the conversion of the color difference signal.

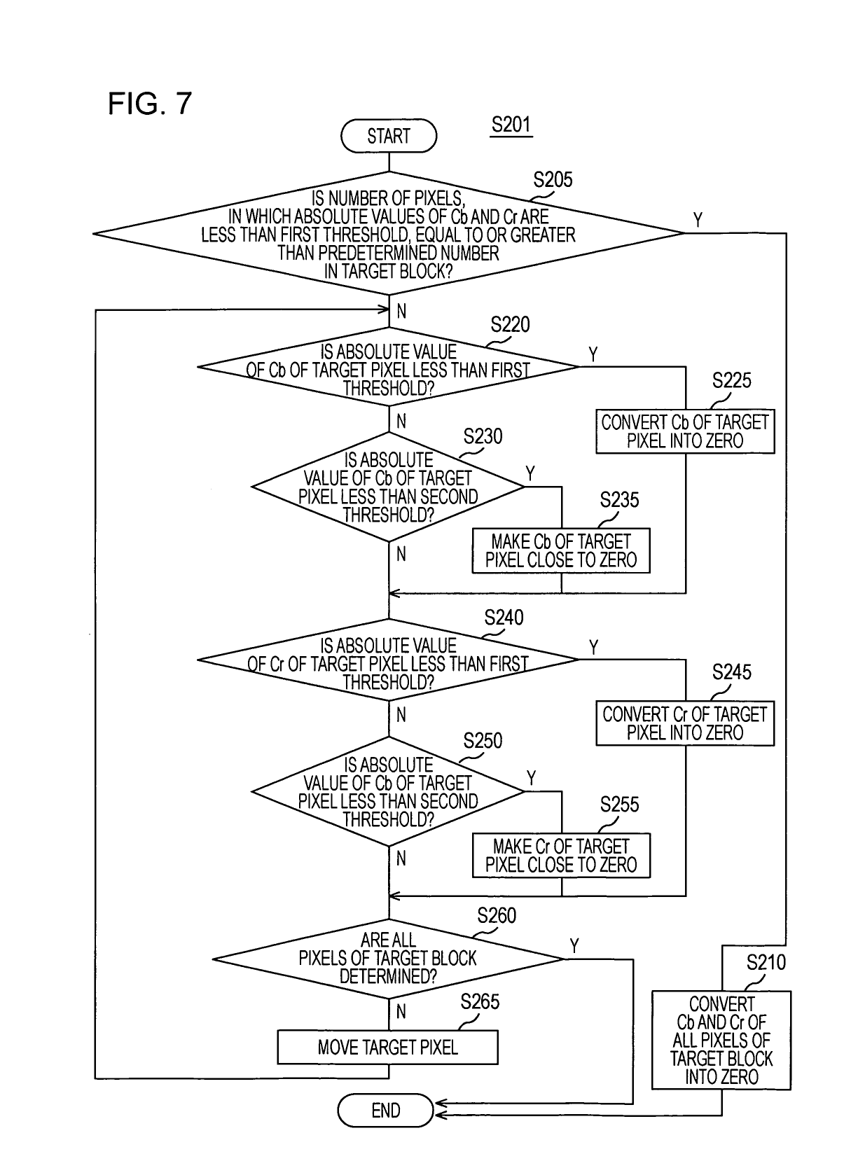

FIG. 7 is a flowchart showing an example of another operation of the scanner 10.

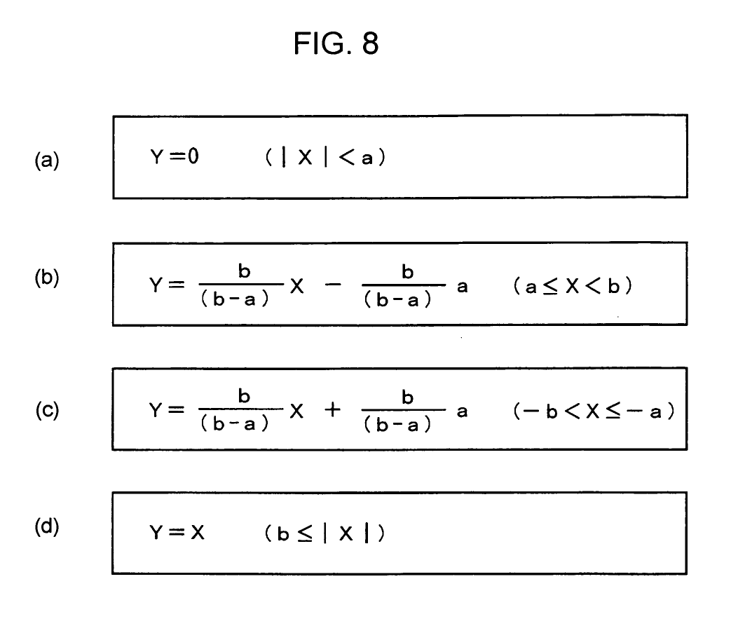

FIG. 8 is a view showing another example of a conversion equation of the color difference signal.

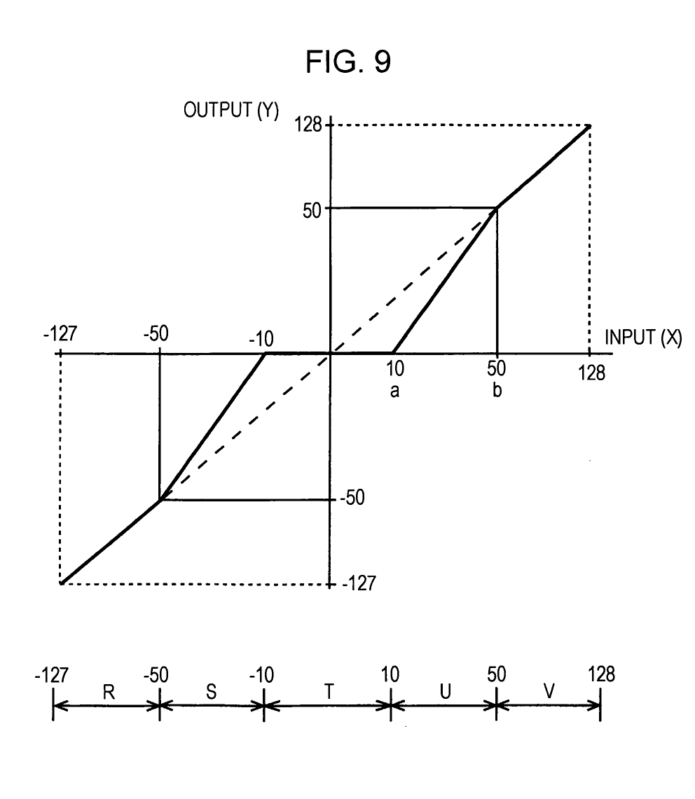

FIG. 9 is a schematic view showing the conversion of the color difference signal.

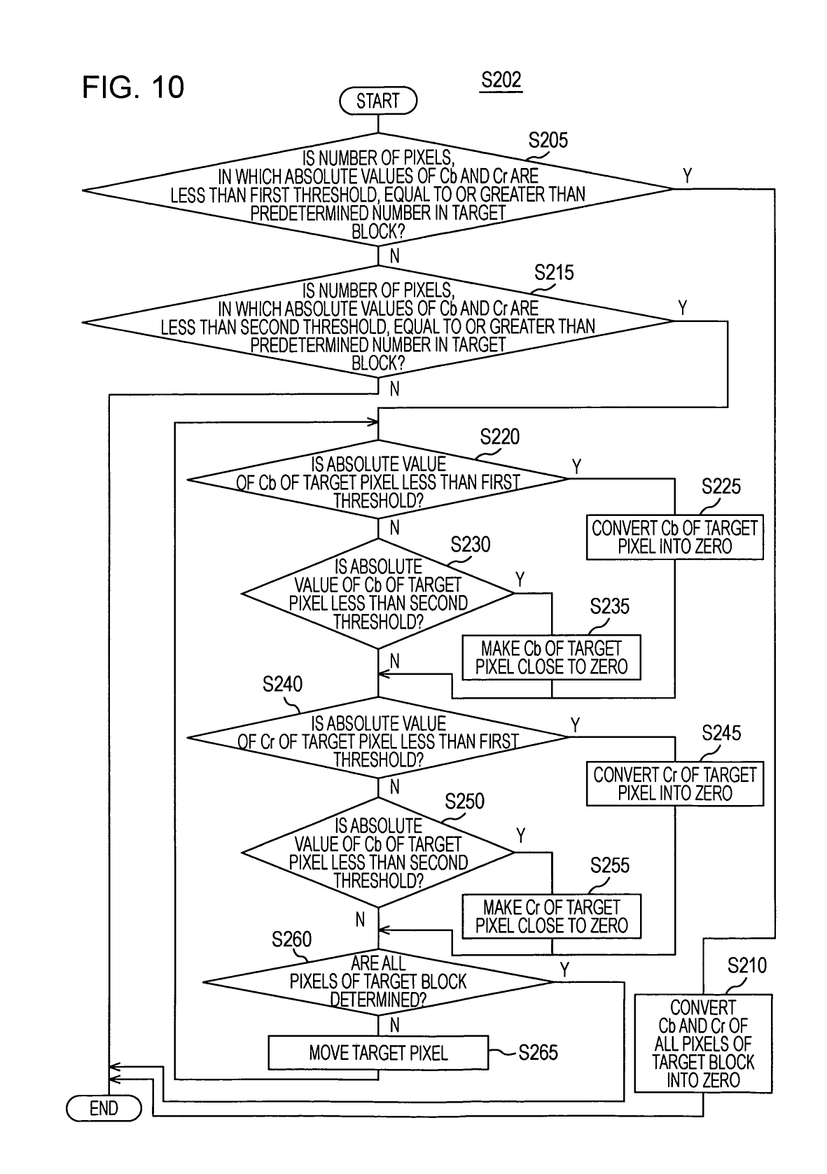

FIG. 10 is a flowchart showing an example of another operation of the scanner 10.

10: scanner, 12: image compression generating unit, 14: liquid crystal monitor, 16: operation panel, 20: personal computer, 22: main body, 24: display, 26: keyboard, 28: mouse, 100: image storage unit, 110: image pickup unit, 120: color space conversion unit, 130: determination unit, 140: monochrome conversion unit, 150: correction value conversion unit, 200: compression unit, 210: spatial frequency conversion unit, 220: quantization unit, 230: entropy encoding unit, 300: decoding unit

### DESCRIPTION OF EXEMPLARY EMBODIMENTS

Hereinafter, the invention will be described with reference to embodiments of the invention, but the following embodiments do not restrict the invention according to claims and the combinations of the features described in the embodiments are not all required in the solving means of the invention.

### Embodiment 1

FIG. 1 is a view showing a scanner 10. The scanner 10 is an example of an image compressing apparatus and includes an operation panel 16 which is an example of input means from a user and a liquid crystal monitor 14 which is an example of output means to the user. This scanner 10 may be a multifunctional machine including a printer function. The scanner 10 receives an instruction of the user via the operation panel 16 and picks up a picture or a photograph using an image pickup device such as a charge coupled device (CCD) for generating a color image. The scanner 10 the color image such as the picked-up picture and photograph to the user via a liquid crystal monitor 14. The scanner 10 outputs the color image to a personal computer 20. The personal computer 20 includes a main body 22, and a display 24 for displaying the image to the user on the basis of the output from the main body 22, and a keyboard 26 and a mouse 28 which are examples of the input means from the user to the main body 22. The personal computer 20 receives the instruction from the user via the keyboard 26 or the like and displays the color image output from the scanner 10 to the liquid crystal monitor 14.

FIG. 2 is a block diagram showing an example of the scanner 10. The scanner 10 includes an image storage unit 100, an image pickup unit 110, an image compression generating unit 12, and a decoding unit 300. The image compression generating unit 12 includes a color space conversion unit 120, a determination unit 130, a monochrome conversion unit 140, a zero value conversion unit 152, a correction value conversion unit 150 and a compression unit 200. The compression unit 200 includes a spatial frequency conversion unit 210, a quantization unit 220 and an entropy encoding unit 230. The image compression generating unit 12 may be an application specific integrated circuit (ASIC).

When the instruction from the user is received via the operation panel 16 shown in FIG. 1, the image pickup unit 110 picks up light reflected from or transmitted through an original by the image pickup device such as the CCD via a RGB filter and outputs the picked-up image to the color space conversion unit 120 as the color image represented by the RGB color space.

The color space conversion unit 120 converts the color image represented by the RGB space output from the image pickup unit 110 into a color image represented by an YCbCr color space. That is, the color space conversion unit 120 converts the color image represented by a R value, a G value and a B value into the color image represented by a brightness signal (hereinafter, referred to as a “brightness signal Y”), a color difference signal of a blue component (hereinafter, referred to as a “color difference component Cb”) and a color difference signal of a red component (hereinafter, referred to as a “color difference component Cr”). Accordingly, it is possible to generate compression image, in which the occurrence of block noise is suppressed, while considering compression efficiency, with respect to the image of the RGB color space. In addition, the color image in which R, G and B are represented by values of 0 to 255 in the RGB space are converted into the color image in which the brightness signal Y is represented by 0 to 255 and the color difference signals Cb and Cr are represented by −128 to 127 in the YCbCr color space. The color space conversion unit 120 inversely converts the color image represented by the YCbCr color space into the color image represented by the RGB space.

The determination unit 130 determines whether the absolute values of the color difference signal Cb and the color difference signal Cr of the pixels of the color image converted into the YCbCr color space by the color space conversion unit 120 are equal to or greater than a first threshold. In more detail, the determination unit 130 divides the color image converted into the YCbCr color space by the color space conversion unit 120 into a plurality of blocks including a plurality of pixels and determines whether the absolute values of the color difference signal Cb and the color difference signal Cr of the pixels included in each of the divided blocks are equal to or greater than the first threshold. The block includes, for example, 8×8 pixels in horizontal and vertical directions, that is, 64 pixels.

The determination unit 130 may, for example, set the color difference signal Cb or Cr output by the color space conversion unit 120 to an integer of −128 to 127, which can be represented by 8 bits, and determine whether the absolute value of the color difference signal Cb or Cr is equal to or greater than the first threshold. In more detail, when the first threshold is a decimal numeral 8, the determination unit 130 refers to five upper bits if a first bit of the color difference signal Cb or Cr is zero, that is, if the color difference signal Cb or Cr is a positive number, and determines that the absolute value of the color difference signal is equal to or greater than the first threshold “8” if any one of the five upper bits is not zero. The determination unit 130 performs the determination similar to the above method after obtaining the absolute value from the complement number of 2, when the first bit of the color difference signal Cb or Cr is 1, that is, when the color difference signal Cb or Cr is a negative number. The determination unit 130 determines whether the number of pixels, in which all the absolute values of the color difference signal Cb and the color difference signal Cr in the pixels included in any block are less than the first threshold, is equal to or greater than a predetermined number.

The monochrome conversion unit 140 converts the values of the color difference signal Cb and the color difference signal Cr of all the pixels of the block into zero if it is determined that the number of pixels, in which all the absolute values of the color difference signal Cb and the color difference signal Cr in the pixels included in any block are less than the first threshold, is equal to or greater than the predetermined number by the determination unit 130. Accordingly, since the output value of the space frequency conversion unit 210 located at a next stage thereof is biased to the zero, the data compression efficiency of the next entropy encoding unit 230 can be improved.

The zero value conversion unit 152 and the correction value conversion unit 150 convert the values of the signals of the pixels of the block as described below if it is determined that the number of pixels, in which all the absolute values of the two color difference signals Cb and Cr in the pixels included in any block are less than the first threshold, is less than the predetermined number by the determination unit 130. First, in the case where it is determined that the number of pixels, in which the absolute values of the two color difference signals Cb and Cr in the pixels included in any block are less than the first threshold, is less than the predetermined number by the determination unit 130, the zero value conversion unit 152 converts the value of the color difference signal Cb into zero when the absolute value of the color difference signal Cb of any pixel of the block is less than the first threshold. Similarly, the zero value conversion unit 152 converts the value of the color difference signal Cr into zero when the absolute value of the color difference signal Cr of any pixel of the block is less than the first threshold.

Meanwhile, when the absolute value of the color difference signal Cb of any pixel of the block is equal to or greater than the first threshold, the correction value conversion unit 150 converts the value of the color difference signal Cb into a correction value close to zero as the absolute value of the color difference signal Cb is decreased. Similarly, when the absolute value of the color difference signal Cr of any pixel of the block is equal to or greater than the first threshold, the correction value conversion unit 150 converts the value of the color difference signal Cr into a correction value close to zero as the absolute value of the color difference signal Cr is decreased. Accordingly, it is possible to generate the compression image in which the occurrence of the block noise is suppressed, while considering the compression efficiency.

In the case where the value of the color difference signal Cb is converted into the correction value close to zero as the absolute value of the color difference signal Cb is decreased, the correction value conversion unit 150 may convert the absolute value of the color difference signal Cb into a correction value from zero to a maximum value (−128 or 127), which can be taken, in proportional to a difference between the absolute value and the first threshold. That is, the correction value conversion unit 150 may previously store a linear function in which the value of the color difference signal Cb is converted into zero when the absolute value of any color difference signal Cb is equal to the first threshold and the value of the color difference signal Cb is taken when the absolute value of any color difference signal Cb is equal to the maximum value. The color difference signal Cr is equal to the color difference signal Cb. Accordingly, it is possible to easily generate the compression image in which the occurrence of the block noise is suppressed.

The compression unit 200 compresses the color image after the color difference signal is converted by the monochrome conversion unit 140 and the correction value conversion unit 150 in the unit of a block. Examples of the compressing method of the compression unit 200 include JPEG and MPEG. In more detail, the spatial frequency conversion unit 210 of the compression unit 200 converts the brightness signal Y, the color difference signal Cb and the color difference signal Cr of a spatial domain into spatial frequencies in a frequency domain in the unit of a block. That is, the spatial frequencies conversion unit 210 the brightness signal Y, the color difference signal Cb and the color difference signal Cr into the spatial frequency using a discrete cosine transform (DCT) in the unit of a block. The quantization unit 220 of the compression unit 200 quantizes the brightness signal Y, the color difference signal Cb and the color difference signal Cr which are converted into the spatial frequencies. The quantization unit 220 may perform quantization with a ratio of the information amounts of the brightness signal Y, the color difference signal Cb and the color difference signal Cr of 4:4:4 or may reduce the information amounts of the color difference signal Cb and the color difference signal Cr in consideration of the compression efficiency and perform quantization, for example, with a ratio of 4:2:2. The entropy encoding unit 230 of the compression unit 200 entropy encodes the quantized brightness signal Y, color difference signal Cb and color difference signal Cr. Accordingly, it is possible to generate a JPEG image in which the occurrence of the block noise is suppressed, while considering the compression efficiency. In addition, “entropy encoding” generally indicates the encoding used for data compression and includes Huffman coding, arithmetic encoding and differential pulse code modulation (DPCM) encoding.

The image storage unit 100 stores the color image compressed by the compression unit 200. The image storage unit 100 outputs the stored color image to the personal computer 20 when the instruction of the user is received via the keyboard 26 or the like of the personal computer 20 or the operation panel 16.

The decoding unit 300 decodes the color image compressed by the compression unit 200 by the inverse process of the compression unit 200. In more detail, the decoding unit 300 decodes the compressed color image stored in the image storage unit 100 when the instruction of the user is received via the operation panel 16. In addition, the color image decoded by the decoding unit 300 is converted into the color image represented by the RGB space by the color space conversion unit 120 and is displayed on the liquid crystal monitor 14.

The personal computer 20 includes a decoding unit and a color space conversion unit (not shown), which are respectively equal to the decoding unit 300 and the compression unit 200 and displays the color image output from the scanner 10 on the display 24 when the instruction of the user is received via the keyboard 26 or the like.

FIG. 3 is a flowchart showing an example of an operation of the scanner 10. The flowchart shown in FIG. 3 is started when the image pickup unit 110 picks up a picture or a photograph.

First, the color space conversion unit 120 converts a R value, a G value and a B value of one target pixel of the color image into the brightness signal Y, the color difference component Cr and the color difference component Cb represented by the YCbCr color space (S100).

The color space conversion unit 120 determines whether all the pixels of the color image are converted (S105). If the color space conversion unit 120 determines that all the pixel of the color image are not converted in a step S105 (S105: No), the target pixel is moved (S110) and the method returns to the step S100. In contrast, if the color space conversion unit 120 determines that all the pixels of the color image are converted in the step S105 (S105: Yes), the determination unit 130 divides the color image, which is converted into the YCbCr color space by the color space conversion unit 120, into a plurality of blocks including 8×8 pixels, that is, 64 pixels in horizontal and vertical directions (S115).

The monochrome conversion unit 140 or the correction value conversion unit 150 converts the color difference signal Cb and the color difference signal Cr of each of the pixels included in the block on the basis of the determination of the determination unit 130 for one target block (S200). The operation of the step S200 will be described in detail with reference to FIG. 4.

The determination unit 130 determines whether all blocks of the color image are determined (S120). If the determination unit 130 determines that all the blocks of the color image are not determined in the step S120 (S120: No), the target block is moved (S125) and the method returns to the step S200. In contrast, if the determination unit 130 determines that all the blocks of the color image are determined in the step S120 (S120: Yes), the spatial frequency conversion unit 210 converts the brightness signal Y, the color difference signal Cb and the color difference signal Cr into the spatial frequencies using the DCT in the unit of a block (S130). The quantization unit 220 quantizes the brightness signal Y, the color difference signal Cb and the color difference signal Cr which are converted into the spatial frequencies, in each block (S135). The quantized brightness signal Y, color difference signal Cb and color difference signal Cr are scanned in a zigzag form and are output to the entropy encoding unit 230 in each block. The entropy encoding unit 230 performs the Huffman coding with respect to the quantized brightness signal Y, color difference signal Cb and color difference signal Cr in each block (S140). The entropy encoding unit 230 stores the brightness signal Y, color difference signal Cb and color difference signal Cr, which are subjected to the Huffman coding process, in the image storage unit 100 (S145). Then, this flowchart is completed. In addition, in the step S100, the color space conversion unit 120 may perform the conversion while the information amounts of the color difference signal Cr and the color difference signal Cb which is unlikely to have an influence on the appearance are reduced. In the step S135, the quantization unit 220 may perform quantization while the information amounts of the color difference signal Cr and the color difference signal Cb are reduced.

FIG. 4 is a flowchart showing an example of the operation of the scanner 10. The flowchart shown in FIG. 4 is executed subsequently to the step S115 or the step S125 shown in FIG. 3. Subsequently to the step S115, the determination unit 130, determines whether the number of pixels, in which all the absolute values of the color difference signal Cb and the color difference signal Cr in the pixels included in one target block are less than the first threshold, is equal to or greater than the predetermined number (S205). If the determination unit 130 determines that the number of pixels, in which all the absolute values of the color difference signal Cb and the color difference signal Cr in the pixel included in the target block are less than the first threshold, is equal to or greater than the predetermined number in the step S205 (S205: Yes), the monochrome conversion unit 140 converts all the values of the color difference signals Cb and the color difference signals Cr of all the pixels included in the block into zero (S210). Accordingly, since the spatial frequency conversion unit 210 located at a next stage is further biased, it is possible to improve the data compression efficiency of the entropy encoding unit 230. This flowchart is completed and progresses to the step S120 shown in FIG. 3.

In contrast, if the determination unit 130 determines that the number of pixels, in which all the absolute values of the color difference signal Cb and the color difference signal Cr in the pixels included in one target block are less than the first threshold, is not equal to or greater than the predetermined number in the step S205 (S205: No), it is determined whether the absolute value of the color difference signal Cb of one target pixel of the block is less than the first threshold (S220). If the determination unit 130 determines that the absolute value of the color difference signal Cb of the target pixel of the block is less than the first threshold (S220: Yes) in the step S220, the zero value conversion unit 152 converts the value of the color difference signal Cb of the pixel into zero (S225).

In contrast, if the determination unit 130 determines that the absolute value of the color difference signal Cb of one target pixel of the block is not less than the first threshold (S220: No) in the step S220, the correction value conversion unit 150 converts the absolute value of the color difference signal Cb of the target pixel into the correction value from zero to the maximum value, which can be taken, in proportional to the difference between the absolute value and the first threshold and converts into the correction value close to zero as the absolute value of the color difference signal Cb is decreased (S235). Accordingly, it is possible to generate the compression image in which the occurrence of the block noise is suppressed.

Subsequently to the step S225 and the step S235, the determination unit 130 determines whether the absolute value of the color difference signal Cr of the target pixel is less that the first threshold (S240). The operation of the color difference signal Cr from the step S240 to the step S255 are equal to that of the color difference signal Cb from the step S220 to the step S235 and thus the description thereof will be omitted.

Subsequently to the step S245 and the step S255, the determination unit 130 determines whether all the pixels of the block are determined (S260). If the determination unit 130 determines that all the pixels of the block are not determined in the step S260 (S260: No), the target pixel is moved (S265) and the method returns to the step S220. In contrast, if the determination unit 130 determines that all the pixels of the block are determined in the step S260 (S260: Yes), this flowchart is completed and progresses to the step S120 shown in FIG. 3.

It is preferable that the predetermined number of the step S205 of the flowchart shown in FIG. 4 is, for example, 59 (=64−5). Accordingly, if there is a majority of pixels, in which all the absolute values of the color difference signal Cb and the color difference signal Cr are less than the first threshold, in the target block, the step S210 is executed.

FIG. 5 is a view showing an example of a conversion equation of a color difference signal. FIG. 6 is a schematic view showing the conversion of the color difference signal. Hereinafter, the flowchart shown in FIG. 4 will be described in detail using FIGS. 5 and 6. In the conversion equation shown in FIG. 5, X, Y and a denote an input value X of the color difference signal before conversion, an output value Y of the color difference signal after conversion and the first threshold a, respectively. In the view shown in FIG. 6, a horizontal axis and a vertical axis denote the input value X and the output value Y, respectively. The first threshold a is “10”.

In the step S225 of FIG. 4, the input value X “7” of the color difference signal Cb of one target pixel of the block is converted into the output value Y “0” by the zero value conversion unit 152 on the basis of the arithmetic equation of FIG. 5A. For example, the input value X “−7”, of the color difference signal Cb of one target pixel of the block is converted into the output value Y “0” by the zero value conversion unit 152 on the basis of the arithmetic equation of FIG. 5A.

In the step S235, for example, the input value X “30” of the color difference signal Cb of one target pixel of the block is converted into the output value Y “25” by the correction value conversion unit 150 on the basis of the arithmetic equation of FIG. 5B. Accordingly, it is possible to generate the compression image in which the occurrence of the block noise is suppressed. For example, the input value X “−30” of the color difference signal Cb of one target pixel of the block is converted into the output value Y “−25” by the correction value conversion unit 150 on the basis of the arithmetic equation of FIG. 5C. The correction value conversion unit 150 may convert the color difference signal Cb into a value approximate to a value calculated by the arithmetic equation of FIG. 5B or FIG. 5c. That is, the arithmetic equation of FIG. 5B or 5C may be an approximate equation.

According to the present embodiment, it is possible to generate the compression image in which the occurrence of the block noise is suppressed, while considering the compression efficiency. Although, in the present embodiment, the zero value conversion unit 152 and the correction value conversion unit 150 convert the color difference signal Cb and the color difference signal Cr by the conversion equation shown in FIG. 5, the image compression generating unit 12 may further include a color difference signal conversion table for converting the color difference signal Cb and the color difference signal Cr, and the correction value conversion unit 150 may convert the color difference signal Cb and the color difference signal Cr using the color difference signal conversion table, instead of the conversion equation shown in FIG. 5.

Although, in the step S200 of the embodiment shown in FIGS. 1 to 6, the correction value conversion unit 150 converts the value of the color difference signal into the correction value using a linear function from zero to the maximum value which can be taken, the conversion method is not limited thereto. As another conversion method, a function other than the linear function may be used. As another conversion method, a second threshold may be set and the value of the color difference signal may be converted into the correction value using the linear function if the absolute value of the color difference signal is in a range from the first threshold to the second threshold and may be output without conversion if the absolute value of the color difference signal is equal to or greater than the second threshold.

FIG. 7 is a flowchart showing an example of another operation (step S201) of the scanner 10 using the second threshold. In the flowchart shown in FIG. 7, the same operations as the flowchart of FIG. 4 are denoted by the step numbers and thus the description thereof will be omitted.

In the flowchart shown in FIG. 7, if the determination unit 130 determines that the number of pixels, in which all the absolute values of the color difference signal Cb and the color difference signal Cr in the pixels included in one target block are less than the first threshold, is not equal to or greater than the predetermined number in the step S205 (S205: No), it is determined whether the absolute value of the color difference signal Cb of the target pixel of the block is less than the first threshold (S220). If the determination unit 130 determines that the absolute value of the color difference signal Cb of the target pixel of the block is less than the first threshold (S220: Yes) in the step S220, the zero value conversion unit 152 converts the value of the color difference signal Cb of the pixel into zero (S225).

In contrast, if the determination unit 130 determines that the absolute value of the color difference signal Cb of one target pixel of the block is not less than the first threshold (S220: No) in the step S220, it is determined whether the absolute value of the color difference signal Cb of the target pixel is less than the second threshold (S230). If the determination unit 130 determines that the absolute value of the color difference signal Cb of the target pixel is less than the second threshold value (S230: Yes) in the step S230, the correction value conversion unit 150 converts the absolute value of the color difference signal Cb of the target pixel into the correction value from zero to the second threshold value in proportional to the difference between the absolute value and the first threshold and converts into the correction value close to zero as the absolute value of the color difference signal Cb is decreased (S235). Accordingly, it is possible to generate the compression image in which the occurrence of the block noise is suppressed.

Subsequently to the step S230 (No), the step S225 and the step S235, the determination unit 130 determines whether the absolute value of the color difference signal Cr of the target pixel is less that the first threshold (S240). The operation of the color difference signal Cr from the step S240 to the step S255 are equal to that of the color difference signal Cb from the step S220 to the step S235 and thus the description thereof will be omitted.

Subsequently to the step S250 (No), the step S245 and the step S255, the determination unit 130 determines whether all the pixels of the block are determined (S260). If the determination unit 130 determines that all the pixels of the block are not determined in the step S260 (S260: No), the target pixel is moved (S265) and the method returns to the step S220. In contrast, if the determination unit 130 determines that all the pixels of the block are determined in the step S260 (S260: Yes), this flowchart is completed and progresses to the step S120 shown in FIG. 3.

FIG. 8 is a view showing another example of a conversion equation of the color difference signal used in the step S201 of FIG. 7. FIG. 9 is a schematic view showing the conversion of the color difference signal. Hereinafter, the flowchart shown in FIG. 7 will be described in detail using FIGS. 8 and 9. In the conversion equation shown in FIG. 8, X, Y, a and b denote an input value X of the color difference signal before conversion, an output value Y of the color difference signal after conversion, the first threshold a and the second threshold b, respectively. In the view shown in FIG. 9, a horizontal axis and a vertical axis denote the input value X and the output value Y, respectively. The first threshold a is “10” and the second threshold b is “50”.

In the step S225 of FIG. 7, the input value X “7” of the color difference signal Cb of one target pixel of the block is converted into the output value Y “0” by the zero value conversion unit 152 on the basis of the arithmetic equation of FIG. 8A. That is, the input value X on a dotted line in a range of T shown in the lower side of the schematic view of FIG. 9 is converted into the output value Y on a solid line in the same range. For example, the input value X “−7” of the color difference signal Cb of one target pixel of the block is converted into the output value Y “0” by the zero value conversion unit 152 on the basis of the arithmetic equation of FIG. 8A.

In the step S235 of FIG. 7, for example, the input value X “30” of the color difference signal Cb of one target pixel of the block is converted into the output value Y “25” by the correction value conversion unit 150 on the basis of the arithmetic equation of FIG. 8B. That is, the input value X on a dotted line in a range of U shown in the lower side of the schematic view of FIG. 9 is converted into the output value Y on a solid line in the same range. Accordingly, it is possible to generate the compression image in which the occurrence of the block noise is suppressed. For example, the input value X “−30” of the color difference signal Cb of one target pixel of the block is converted into the output value Y “−25” by the correction value conversion unit 150 on the basis of the arithmetic equation of FIG. 8C. That is, the input value X on a dotted line in a range of S shown in the lower side of the schematic view of FIG. 9 is converted into the output value Y on a solid line in the same range. Accordingly, it is possible to generate the compression image in which the occurrence of the block noise is suppressed. The correction value conversion unit 150 may convert the color difference signal Cb into a value approximate to a value calculated by the arithmetic equation of FIG. 8B or FIG. 8c. That is, the arithmetic equation of FIG. 5B or 8C may be an approximate equation.

In the step S230 of FIG. 7, for example, the input value X “80” of the color difference signal Cb of one target pixel of the block is output without conversion as the output value Y “80” on the basis of the arithmetic equation of FIG. 8D. That is, the input value X on a solid line in a range of V shown in the lower side of the schematic view of FIG. 9 is output without conversion as the output value Y. For example, the input value X “−80” of the color difference signal Cb of one target pixel of the block is output without conversion as the output value Y “−80” on the basis of the arithmetic equation of FIG. 8D. That is, the input value X on a solid line in a range of R shown in the lower side of the schematic view of FIG. 9 is output without conversion as the output value Y.

According to the present embodiment, it is possible to suppress the occurrence of the block noise while shortening a time necessary for compression and generate a compression image in which an original image color is maintained.

FIG. 10 is a flowchart showing an example of another operation (step S202) of the scanner 10. In the flowchart shown in FIG. 10, the same operations as the flowchart of FIG. 7 are denoted by the same step numbers and thus the description thereof will be omitted.

In the flowchart shown in FIG. 10, if the determination unit 130 determines that the number of pixels, in which all the absolute values of the color difference signal Cb and the color difference signal Cr in the pixels included in one target block are less than the first threshold, is not equal to or greater than the predetermined number in the step S205 (S205: No), it is determined whether the number of pixels, in which all the absolute values of the color difference signal Cb and the color difference signal Cr in the pixel included in the block are less than the second threshold, is equal to or greater than a predetermined number (S215).

If the determination unit 130 determines that the number of pixels, in which all the absolute values of the color difference signal Cb and the color difference signal Cr in the pixel included in the block are less than the second threshold, is equal to or greater than the predetermined number in the step S215 (S215: Yes), it is determined whether the absolute value of the color difference signal Cb of one target pixel of the block is less than the first threshold (S220). The subsequent operations thereof are equal to those of the flowchart shown in FIG. 7 and thus the description thereof will be omitted.

If the determination unit 130 determines that the number of pixels, in which all the absolute values of the color difference signal Cb and the color difference signal Cr in the pixel included in the block are less than the second threshold, is not equal to or greater than a predetermined number in the step S215 (S215: No), this flowchart is completed and progresses to the step S120 shown in FIG. 3.

The predetermined number of the step S215 of the flowchart shown in FIG. 10 may be equal to or different from the predetermined number of step S205. Accordingly, in the target block, if the number of pixels, in which all the absolute values of the color difference signal Cb and the color difference signal Cr are less than the second threshold, is small, it is possible to suppress the occurrence of the block noise while maintaining an original image color.

Although, in the present embodiment, the scanner 10 is used as the image compressing apparatus, the image compressing apparatus may be a digital camera. The image compressing apparatus may be a personal computer in which a software driver for controlling the scanner 10 or the digital camera is installed. In this case, the software driver may be stored in the personal computer via a CD-ROM or a network.

Although the invention is described with reference to the embodiments, the technical scope of the invention is not limited to the range of the embodiments. It is apparent to those skilled in the art that various modifications or improvements are possible. It is apparent from the description of claims that the modifications or improvements are included in the technical scope of the invention.

1. An image compressing method of dividing and compressing a color image, in which each of pixels is represented by a brightness signal and two color difference signals, into a plurality of blocks including a plurality of pixels, the image compressing method comprising:
a determining step of determining whether absolute values of the color difference signals of the pixels of the color image are equal to or greater than a first threshold;
a monochrome converting step of converting all the values of the two color difference signals of all the pixels included in a block into zero, if it is determined that the number of pixels, in which all the absolute values of the two color difference signals in the pixels included in the block are less than the first threshold is equal to or greater than a predetermined number, on the basis of the determined result of the determining step;
a zero value converting step of extracting a pixel, in which the absolute value of one color difference signal is less than the first threshold, from the block and converting the value of the color difference signal of the extracted pixel into zero, if it is determined that the number of pixels, in which all the absolute values of the two color difference signals in the pixels included in the block are less than the first threshold is less than the predetermined number, on the basis of the determined result of the determining step;
a correction value converting step of extracting a pixel, in which the absolute value of one color difference signal is equal to or greater than the first threshold, from the block and converting the value of the color difference signal of the extracted pixel into a correction value close to zero as the absolute value of the color difference signal is decreased, if it is determined that the number of pixels, in which all the absolute values of the two color difference signals in the pixels included in the block are less than the first threshold is less than the predetermined number, on the basis of the determined result of the determining step; and
a compressing step of compressing the color image including the block in which the color difference signal is converted by at least one of the monochrome converting step, the zero value converting step or the correction value converting step.

2. The image compressing method according to claim 1, wherein a function for converting the value of the color difference signal into the correction value by the correction value converting step outputs a maximum value if the absolute value of the color difference signal of the pixel is the maximum value, which can be taken with respect to the color difference signal, and outputs zero if the absolute value of the color difference signal of the pixel is the same value as the first threshold.

3. The image compressing method according to claim 1, wherein:
the determining step further comprises determining whether the absolute values of the color difference signals of the pixels of the color image are equal to or greater than a second threshold greater than the first threshold, and
the correction value converting step comprises extracting a pixel, in which the absolute value of one color difference signal is equal to or greater than the second threshold, from the block and outputting the value of the color difference signal of the extracted pixel without conversion, on the basis of the determined result of the determining step.

4. The image compressing method according to claim 1, wherein:
the determining step further comprises determining whether the absolute values of the color difference signals of the pixels of the color image are equal to or greater than a second threshold greater than the first threshold, and
the correction value converting step comprises outputting the values of the color difference signals of all the pixels included in the block without conversion, if it is determined that the number of pixels, in which all the absolute values of the two color difference signals in the pixels included in the block are equal to greater than the second threshold is equal to or greater than the predetermined number, on the basis of the determined result of the determining step.

5. An image compressing apparatus for dividing and compressing a color image, in which each of pixels is represented by a brightness signal and two color difference signals, into a plurality of blocks including a plurality of pixels, the image compressing apparatus comprising:
a determination unit which determines whether absolute values of the color difference signals of the pixels of the color image are equal to or greater than a first threshold;
a monochrome conversion unit which converts all the values of the two color difference signals of all the pixels included in a block into zero, if it is determined that the number of pixels, in which all the absolute values of the two color difference signals in the pixels included in the block are less than the first threshold is equal to or greater than a predetermined number, on the basis of the determined result of the determination unit;
a zero value conversion unit which extracts a pixel, in which the absolute value of one color difference signal is less than the first threshold, from the block and converts the value of the color difference signal of the extracted pixel into zero, if it is determined that the number of pixels, in which all the absolute values of the two color difference signals in the pixels included in the block are less than the first threshold is less than the predetermined number, on the basis of the determined result of the determination unit;
a correction value conversion unit which extracts a pixel, in which the absolute value of one color difference signal is equal to or greater than the first threshold, from the block and converts the value of the color difference signal of the extracted pixel into a correction value close to zero as the absolute value of the color difference signal is decreased, if it is determined that the number of pixels, in which all the absolute values of the two color difference signals in the pixels included in the block are less than the first threshold is less than the predetermined number, on the basis of the determined result of the determination unit; and
a compression unit which compresses the color image including the block in which the color difference signal is converted by at least one of the monochrome conversion unit, the zero value conversion unit or the correction value conversion unit.

6. The image compressing apparatus according to claim 5, wherein a function for converting the value of the color difference signal into the correction value by the correction value conversion unit outputs a maximum value if the absolute value of the color difference signal of the pixel is the maximum value, which can be taken with respect to the color difference signal, and outputs zero if the absolute value of the color difference signal of the pixel is the same value as the first threshold.

7. The image compressing apparatus according to claim 5, wherein:
the determination unit determines whether the absolute values of the color difference signals of the pixels of the color image are equal to or greater than a second threshold greater than the first threshold, and
the correction value conversion unit extracts a pixel, in which the absolute value of one color difference signal is equal to or greater than the second threshold, from the block and outputting the value of the color difference signal of the extracted pixel without conversion, on the basis of the determined result of the determining step.

8. The image compressing apparatus according to claim 5, wherein:
the determination unit determines whether the absolute values of the color difference signals of the pixels of the color image are equal to or greater than a second threshold greater than the first threshold, and
the correction value conversion unit outputs the values of the color difference signals of all the pixels included in the block without conversion, if it is determined that the number of pixels, in which all the absolute values of the two color difference signals in the pixels included in the block are equal to greater than the second threshold is equal to or greater than the predetermined number, on the basis of the determined result of the determining step.
